(19) United States
(12) Patent Application Publication
(10) Pub. No.: US 2016/0063064 A1
(43) Pub. Date: Mar. 3, 2016

(54) RECORDING REASONS FOR METADATA CHANGES

(71) Applicant: International Business Machines Corporation, Armonk, NY (US)

(72) Inventor: Darin T. Tanikawa, Irvine, CA (US)

(21) Appl. No.: 14/470,658

(22) Filed: Aug. 27, 2014

(51) Int. Cl. G06F 17/30

(52) U.S. Cl. CPC G06F 17/30525; G06F 17/30345; G06F 17/30011

(57) ABSTRACT

Provided are techniques for recording reasons for metadata changes. In response to receiving a change to a metadata of a document, a reason for the change is requested. In response to receiving the reason, the reason is saved as additional metadata for the document. A reason indicator is associated with the metadata.

### FIELD

Embodiments of the invention relate to recording reasons for metadata changes. Certain embodiments related to document capture that allows a user to record a reason for changes during document indexing verification.

### BACKGROUND

A document capture process involves capturing documents and turning those documents into digital images, extracting information from those digital images, and inserting the images with some metadata into a repository. Document capture systems may perform the following capture tasks: scanning, image processing, separation and classification of images, data extraction, data validation, and indexing.

### SUMMARY

Provided is a method for recording reasons for metadata changes. The method comprises: in response to receiving a change to a metadata of a document, requesting a reason for the change; in response to receiving the reason, saving the reason as additional metadata for the document; and associating a reason indicator with the metadata.

Provided is a computer program product for recording reasons for metadata changes. The computer program product comprising a computer readable storage medium having program code embodied therewith, the program code executable by at least one processor to perform: in response to receiving a change to a metadata of a document, requesting a reason for the change; in response to receiving the reason, saving the reason as additional metadata for the document; and associating a reason indicator with the metadata.

Provided is a computer system for recording reasons for metadata changes. The computer system comprises one or more processors, one or more computer-readable memories and one or more computer-readable, tangible storage devices; and program instructions, stored on at least one of the one or more computer-readable, tangible storage devices for execution by at least one of the one or more processors via at least one of the one or more memories, to perform: in response to receiving a change to a metadata of a document, requesting a reason for the change; in response to receiving the reason, saving the reason as additional metadata for the document; and associating a reason indicator with the metadata.

### BRIEF DESCRIPTION OF THE SEVERAL VIEWS OF THE DRAWINGS

Referring now to the drawings in which like reference numbers represent corresponding parts throughout:

FIG. 1 illustrates, in a block diagram, a computing environment in accordance with certain embodiments.

FIG. 2 illustrates, in a flow diagram, operations for document processing in accordance with certain embodiments.

FIG. 3 illustrates a verification user interface in accordance with certain embodiments.

FIG. 4 illustrates a reason indicator for changed metadata in accordance with certain embodiments

FIG. 5 illustrates selection of a reason indicator in accordance with certain embodiments.

FIGS. 6A and 6B illustrate, in a flow diagram, operations performed to associate a reason with a change to metadata in accordance with certain embodiments.

FIG. 7 illustrates, in a block diagram, operations performed to view a reason associated with a change to metadata in accordance with certain embodiments.

FIG. 8 illustrates a cloud computing node in accordance with certain embodiments.

FIG. 9 illustrates a cloud computing environment in accordance with certain embodiments.

FIG. 10 illustrates abstraction model layers in accordance with certain embodiments.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

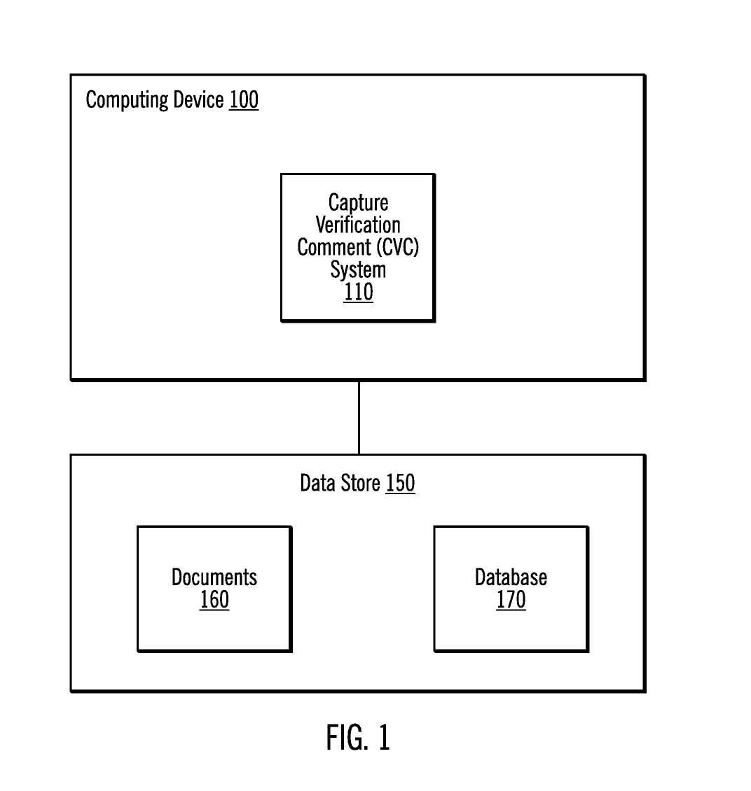

FIG. 1 illustrates, in a block diagram, a computing environment in accordance with certain embodiments. In FIG. 1, a computing device 100 is coupled to a data store 150. The computing device includes a Capture Verification Comment (CVC) system 110. The data store 150 includes documents 160 and a database 170. In certain embodiments, a document 160 is a set of one or more scanned, digital images. The database 170 has one or more database tables. Each of the database tables has columns and rows forming cells for storing data.

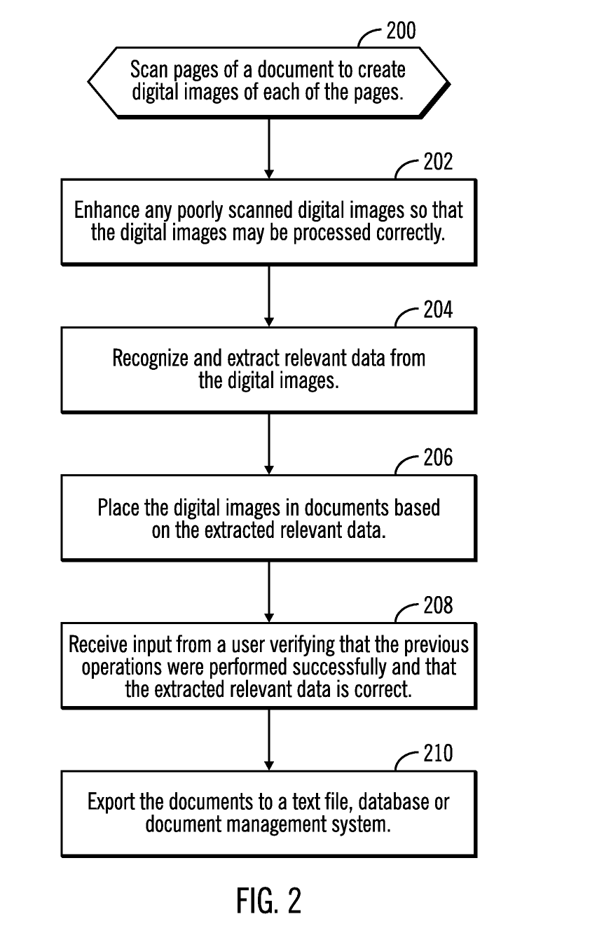

FIG. 2 illustrates, in a flow diagram, operations for document processing in accordance with certain embodiments. Control begins at block 200, for image input, with the CVC system 110 scanning pages of a document to create digital images of each of the pages. In block 202, for digital image processing, the CVC system 110 enhances any poorly scanned digital images so that the digital images may be processed correctly. In block 204, for digital image recognition, the CVC system 110 recognizes and extracts relevant data from the digital images. The extracted data may be stored as metadata (e.g., in one or more database tables). In certain embodiments, the metadata may be used to index the document or search for the document. In certain embodiments, the extraction is performed using optical character recognition. In block 206, for document creation, the CVC system 110 places the digital images in documents based on the extracted relevant data. In block 208, for verification, the CVC system 110 receives input from a user verifying that the previous operations were performed successfully and that the extracted relevant data is correct. In block 210, for export, the CVC system 110 exports the documents to a text file, database or document management system.

With embodiments, for a capture process, scanned images go through a clean-up process in which poor quality images are enhanced so that the recognition phase may correctly recognize and extract the data from those images. Once the data has been extracted and saved as metadata, the images are placed into documents based on that metadata. Before the documents are placed into a document management system, the documents go through the verification process. During the verification process, the user looks at the extracted data (metadata) and verifies that the extracted data (metadata) is correct. In certain embodiments, the user performing the verification process is presented with a verification user interface that shows the extracted data (metadata). In such embodiments, the user is given the ability to make any corrections to the extracted data (metadata) using the verification user interface.

When a first user makes a change to some metadata that that the first user thinks is incorrect, those changes may not be correct. A second user may display the document after the document has been placed into the document management system and discover that the metadata is incorrect. Even though the metadata may be corrected within the document management system, it is helpful to the second user to know why the first user changed the metadata before the export process. Likewise, it is useful for an administrator of the capture process to know why changes are being made. Then, the administrator may determine what types of problems may be occurring during other phases of the capture process. For example, the administrator may determine that the optical character recognition may be consistently extracting incorrect numerical data because of a character recognition engine is configured incorrectly.

With embodiments, the CVC system 110 provides the first user with a verification reason user interface (e.g., a dialog box) each time that the first user makes a change to any metadata within the verification user interface. Inside the verification reason user interface, the first user may describe the reason for changing the data, and the reason may be recorded as additional document metadata. Also, the verification reason user interface may provide other reasons for changes made by other users. In certain embodiments, the verification reason user interface provides other information, such as an identifier of the user who provided the reason. For example, the user may notice that the data fields have improper values (e.g., date values may be assigned to a numeric field) every time, which is an indication that there is a mismatch of data types. Thus, the verification reason user interface provides historical data.

In certain embodiments, there are other means (other than the verification user interface) through which a reason for a metadata change may be requested.

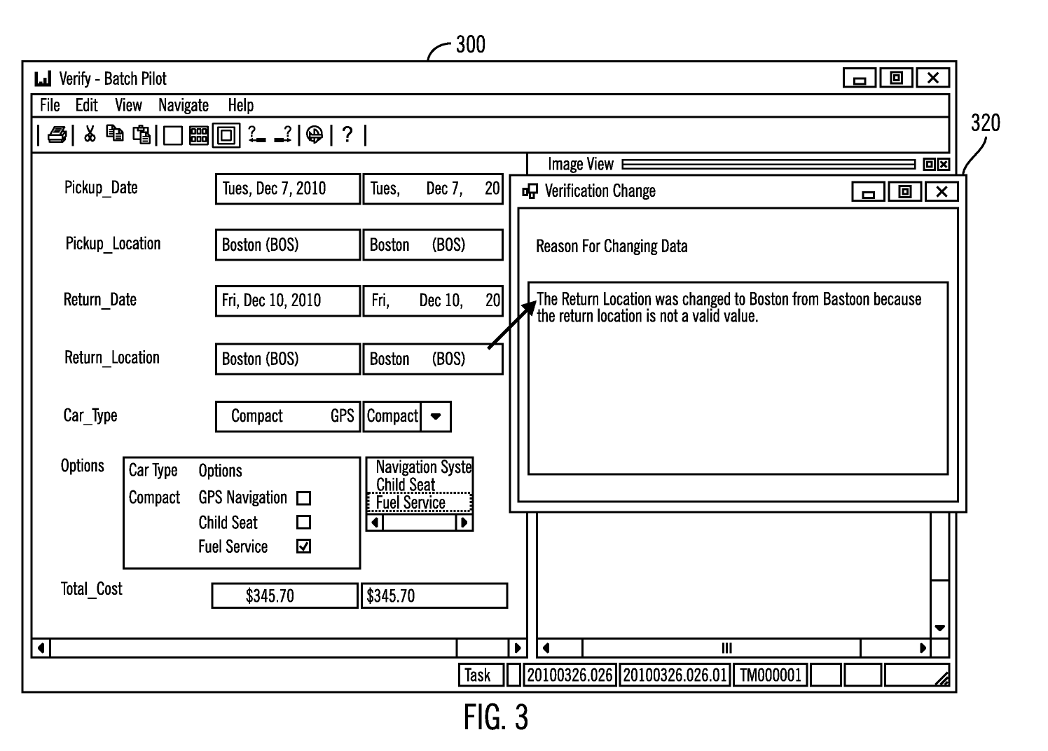

FIG. 3 illustrates a verification user interface 300 in accordance with certain embodiments. With reference to the verification user interface 300, a user has changed the “Return_Location” data field to store the metadata “Boston”, and the CVC system 110 has provided the user with a verification reason user interface 310. The user provides a reason for the change in the verification reason user interface 310.

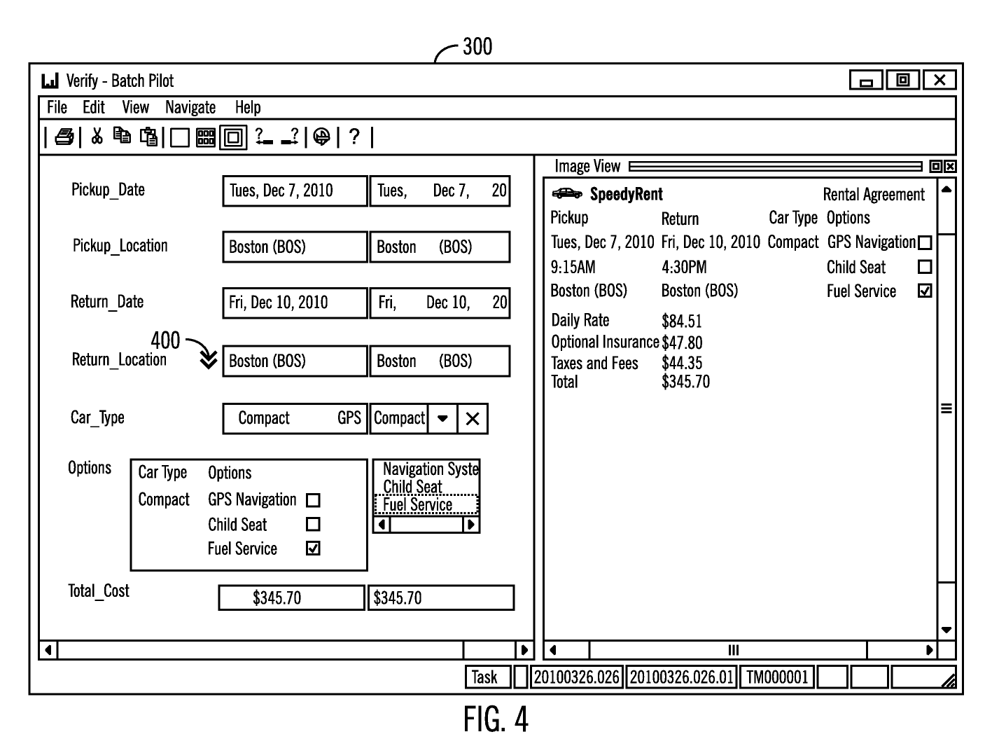

FIG. 4 illustrates a reason indicator 400 for changed metadata in accordance with certain embodiments. Once the user has changed data, the CVC system 110 adds a reason indicator 400 next to the changed data in the verification user interface 300. In various embodiments, the reason indicator may be a symbol with two arrows, changing the data field to a different color, highlighting the data field, etc.

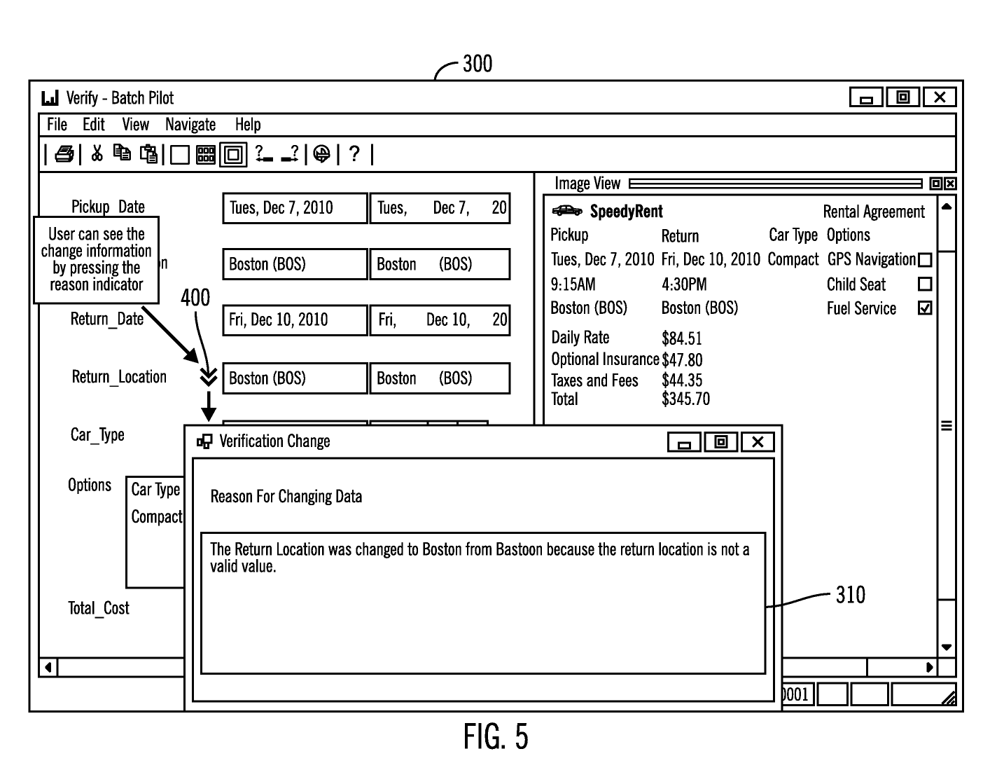

FIG. 5 illustrates selection of the reason indicator 400 in accordance with certain embodiments. When a user selects the reason indicator 310 (e.g., using an input device, such as a mouse, pen, finger, etc.), the CVC system 110 displays the verification reason user interface 310.

When a first user changes metadata in a data field, the CVC system 110 provides the verification reason user interface to enable the first user to enter a reason for the change). Then, the CVC system 110 adds the reason indicator to the data field. At a later time, a second user (e.g., a system administrator), sees that a particular field has been changed and may select the reason indicator 310 to obtain the reason for the change by the first user. That is, the reason indicator allows the second user to quickly see which data fields of the verification user interface have been modified and have associated reasons for change.

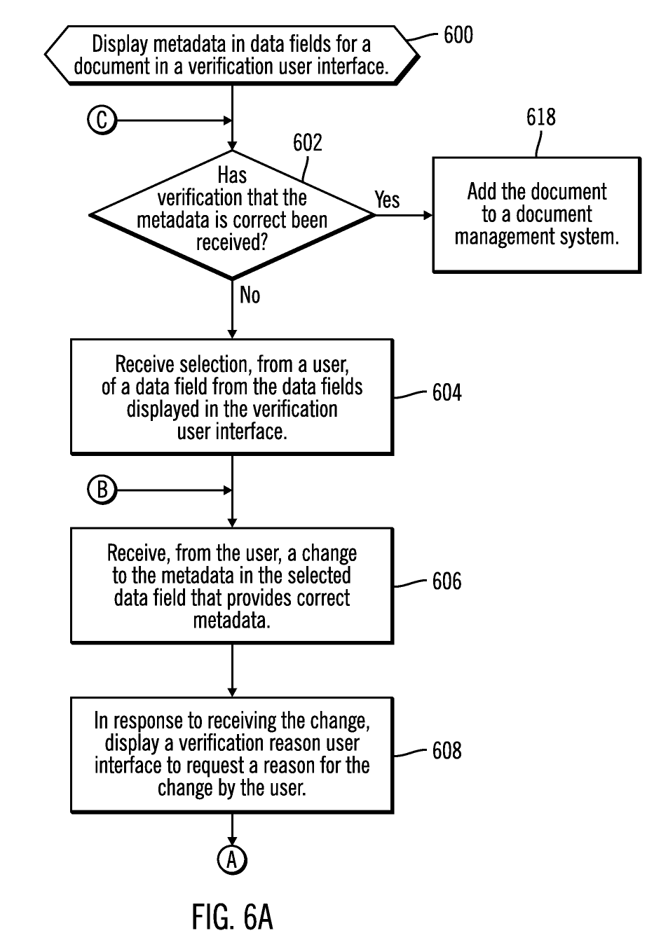

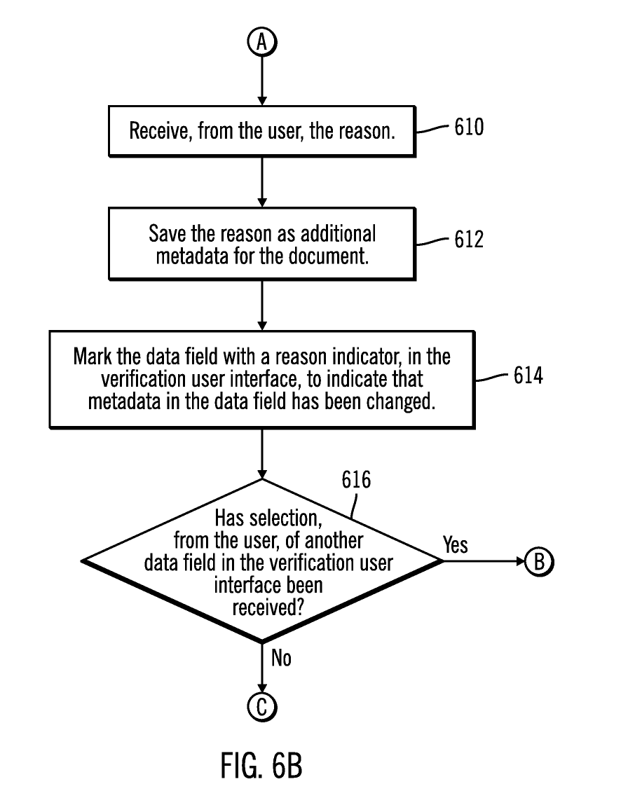

FIGS. 6A and 6B illustrate, in a flow diagram, operations performed to associated a reason with a change to metadata in accordance with certain embodiments. Control begins at block 600 with the CVC system 110 displays metadata in data fields for a document in a verification user interface. In block 602, the CVC system 110 determines whether verification that the metadata is correct has been received. In certain embodiments, a check box is provided, and a user may select the checkbox to indicate that the metadata has been verified as correct (i.e., has been validated). If so, processing continues to block 618, otherwise, processing continues to block 604.

In block 604, the CVC system 110 receives selection, from a user, of a data field from the data fields displayed in the verification user interface. In block 606, the CVC system 110 receives, from the user, a change to the metadata in the selected data field that provides updated metadata (e.g., replaces metadata that the user believes is incorrect with metadata that the user believes is correct or adds additional metadata to what is currently there).

In block 608, the CVC system 110, in response to receiving the change, displays a verification reason user interface to request a reason for the change by the user. From block 608 (FIG. 6A), processing continues to block 610 (FIG. 6B). In block 610, the CVC system receives, from the user, the reason. The user may also provide other information, such as a user identifier, that is saved along with the reason. In certain embodiments, the user identifier is determined automatically (e.g., based on user login information for the current user) or the document in a database table storing that metadata. In block 614, the CVC system 110 marks the data field with a reason indicator, in the verification user interface, to indicate that metadata in the data field has been changed. In block 616, the CVC system 110 determines whether selection, from the user, of another data field in the verification user interface has been received. If so, processing continues to block 606 (FIG. 6A), otherwise, processing continues to block 602 (FIG. 6A).

In block 618, the CVC system 110 adds the document to a document management system.

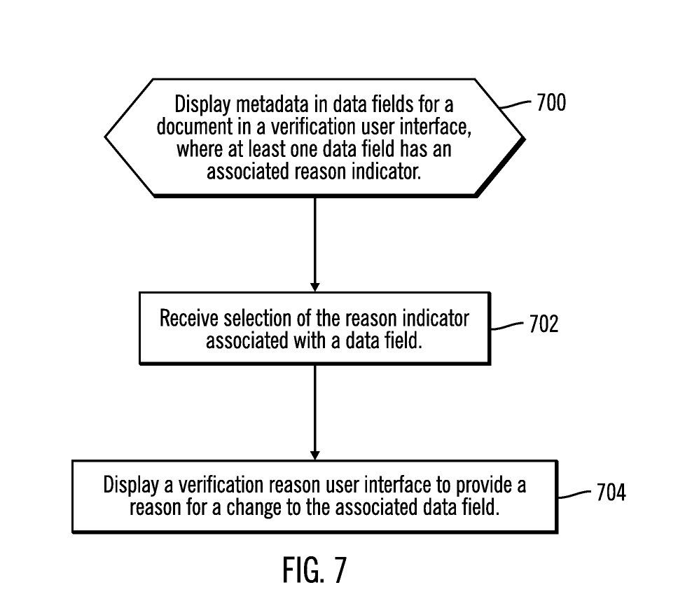

FIG. 7 illustrates, in a block diagram, operations performed to view a reason associated with a change to metadata in accordance with certain embodiments. Control begins at block 700 with the CVC system 110 displaying metadata in data fields for a document in a verification user interface, where at least one data field has an associated reason indicator. In block 702, the CVC system 110 receives selection of a reason indicator associated with a data field. In block 704, the CVC system 110 displays a verification reason user interface to provide a reason (and, optionally, other data) for a change to the associated data field.

In certain embodiments, the document verification process begins with a first user (e.g., a verification operator) looking at the extracted metadata that is displayed in the verification user interface. If the metadata is correct, then the first user makes no changes and the document is added to the document management system. If the first user determines that the extracted metadata is incorrect, the first user selects and changes the incorrect metadata in the verification user interface. Once the metadata is changed, the first user is presented with the verification reason user interface and enters the reason why the metadata was changed. The reason for the change is saved on the document or is associated with the document. Then, the document is added to the document management system.

In addition, a second user (e.g., a capture administrator) may look at the document after the document is added to the document management system and view and analyze the reason the metadata was changed.

With embodiments, the CVC system 110 records the reason the user changed metadata during a verification phase of a capture process, before the document has been stored. In certain embodiments, the metadata is stored in a set of database tables when the metadata is first extracted during the digital image recognition process. When the user updates or changes the metadata during the verification phase, the database tables store the new metadata value. The reason for the change is also stored in the same database tables. Thus, all the information (e.g., user, metadata, reason, etc.) that appears in the verification user interface 300 is stored in those same database tables. In certain embodiments, the metadata and the reason are stored in a row of a database table (e.g., either in a same column or in different columns).

With embodiments, the capture process is integrated with a document management system, such as an Enterprise Content Management (ECM) system. The document management system manages documents, and, when a document is added to the document management system, that document may be later retrieved. In order for retrieval to work correctly, metadata (e.g., social security number, customer ID number, etc.) is extracted from a document, attached to the document checked in to the document management system, and used for retrieval of the document.

By enabling verification of the extracted metadata and providing reasons for changes, the CVC system 110 avoids problems, such as a customer service representative for an insurance company incorrectly retrieving a document from the document management system and presenting someone else's personal information to a customer. The insurance company may be held to liable for exposing another person's information.

Compliance with federal regulations is one of reasons an organization implements a document management system. For example, banking and financial institutions have a number of federal regulations that are to be followed and work to ensure that any banking or financial data that is added to the document management system is accurate. In addition, the CVC system 110 provides historical data (e.g., the reasons) that may explain any discrepancies that appear in the metadata. Also, by storing reasons for user changes to metadata (which may be used for indexing), may help enterprises meet their compliance issues. For example, a manager of the document management system is able to read a record describing why metadata has changed. As another example, standards such as Health Insurance Portability and Accountability Act (HIPAA), require appropriate administrative, physical, and technical policies to ensure the confidentiality and security of electronic personal health information. Thus, having the use of a verification user interface that allows a user to document why metadata was changed may make a difference in a capture solution being HIPAA compliant.

### Cloud Embodiments

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

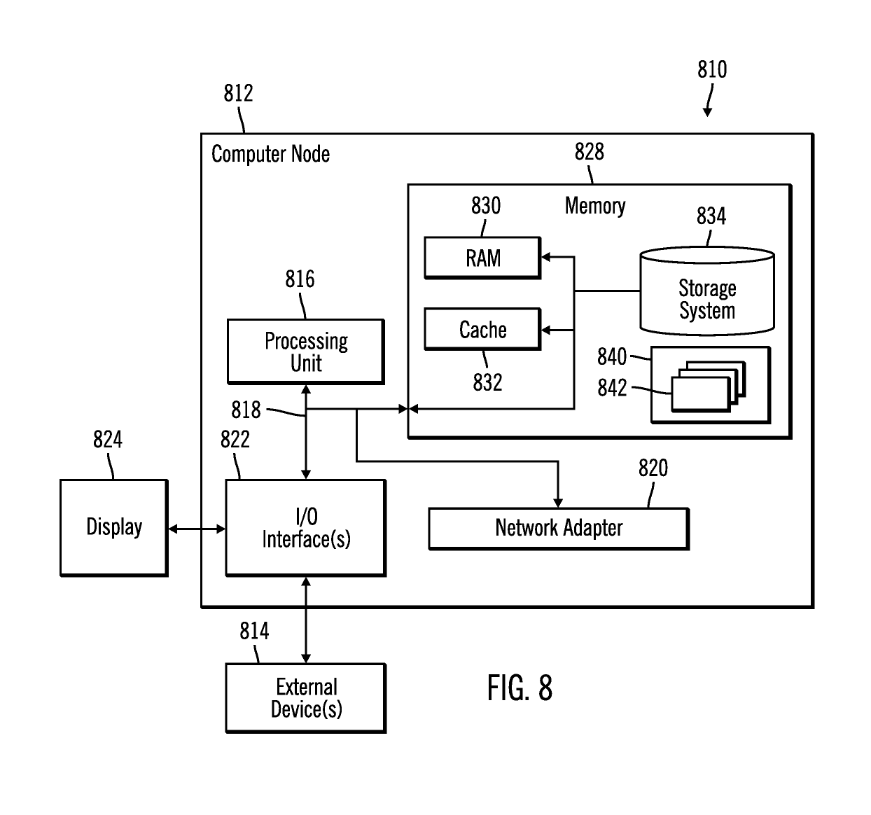

Referring now to FIG. 8, a schematic of an example of a cloud computing node is shown. Cloud computing node 810 is only one example of a suitable cloud computing node and is not intended to suggest any limitation as to the scope of use or functionality of embodiments of the invention described herein. Regardless, cloud computing node 810 is capable of being implemented and/or performing any of the functionality set forth hereinabove.

In cloud computing node 810 there is a computer system/server 812, which is operational with numerous other general purpose or special purpose computing system environments or configurations. Examples of well-known computing systems, environments, and/or configurations that may be suitable for use with computer system/server 812 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 812 may be described in the general context of computer system executable instructions, such as program modules, being executed by a computer system. Generally, program modules may include routines, programs, objects, components, logic, data structures, and so on that perform particular tasks or implement particular abstract data types. Computer system/server 812 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 812 in cloud computing node 810 is shown in the form of a general-purpose computing device. The components of computer system/server 812 may include, but are not limited to, one or more processors or processing units 816, a system memory 828, and a bus 818 that couples various system components including system memory 828 to processor 816.

Bus 818 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 812 typically includes a variety of computer system readable media. Such media may be any available media that is accessible by computer system/server 812, and it includes both volatile and non-volatile media, removable and non-removable media.

System memory 828 can include computer system readable media in the form of volatile memory, such as random access memory (RAM) 830 and/or cache memory 832. Computer system/server 812 may further include other removable/non-removable, volatile/non-volatile computer system storage media. By way of example only, storage system 834 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 818 by one or more data media interfaces. As will be further depicted and described below, memory 828 may include at least one program product having a set (e.g., at least one) of program modules that are configured to carry out the functions of embodiments of the invention.

Program/utility 840, having a set (at least one) of program modules 842, may be stored in memory 828 by way of example, and not limitation, as well as an operating system, one or more application programs, other program modules, and program data. Each of the operating system, one or more application programs, other program modules, and program data or some combination thereof, may include an implementation of a networking environment. Program modules 842 generally carry out the functions and/or methodologies of embodiments of the invention as described herein.

Computer system/server 812 may also communicate with one or more external devices 814 such as a keyboard, a pointing device, a display 824, etc.; one or more devices that enable a user to interact with computer system/server 812; and/or any devices (e.g., network card, modem, etc.) that enable computer system/server 812 to communicate with one or more other computing devices. Such communication can occur via Input/Output (I/O) interfaces 822. Still yet, computer system/server 812 can communicate with one or more networks such as a local area network (LAN), a general wide area network (WAN), and/or a public network (e.g., the Internet) via network adapter 820. As depicted, network adapter 820 communicates with the other components of computer system/server 812 via bus 818. It should be understood that although not shown, other hardware and/or software components could be used in conjunction with computer system/server 812. Examples, include, but are not limited to: microcode, device drivers, redundant processing units, external disk drive arrays, RAID systems, tape drives, and data archival storage systems, etc.

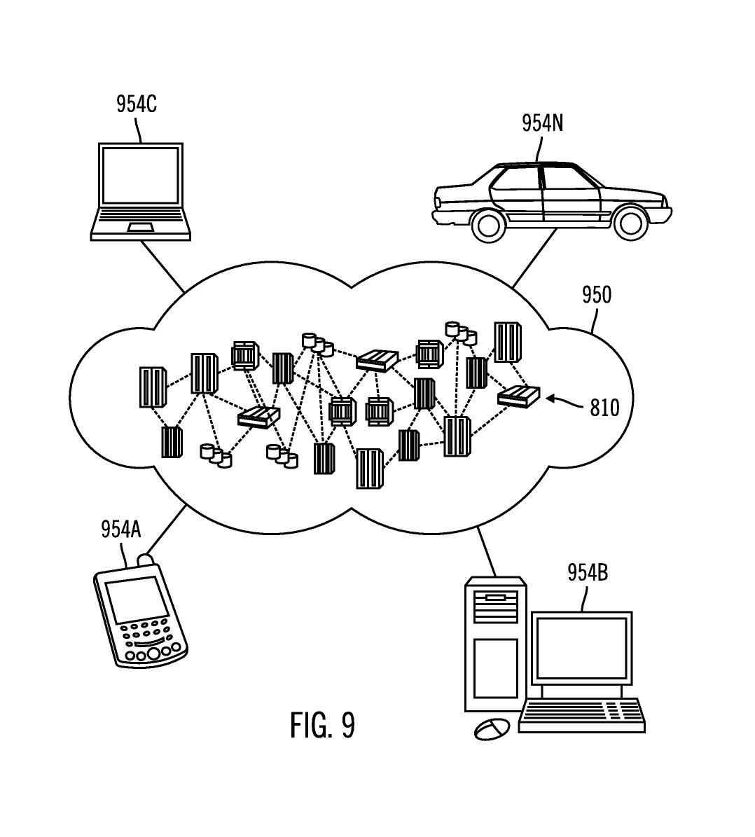

Referring now to FIG. 9, illustrative cloud computing environment 950 is depicted. As shown, cloud computing environment 950 comprises one or more cloud computing nodes 810 with which local computing devices used by cloud consumers, such as, for example, personal digital assistant (PDA) or cellular telephone 954A, desktop computer 954B, laptop computer 954C, and/or automobile computer system 954N may communicate. Nodes 810 may communicate with one another. They may be grouped (not shown) physically or virtually, in one or more networks, such as Private, Community, Public, or Hybrid clouds as described hereinabove, or a combination thereof. This allows cloud computing environment 950 to offer infrastructure, platforms and/or software as services for which a cloud consumer does not need to maintain resources on a local computing device. It is understood that the types of computing devices 954A-N shown in FIG. 9 are intended to be illustrative only and that computing nodes 810 and cloud computing environment 950 can communicate with any type of computerized device over any type of network and/or network addressable connection (e.g., using a web browser).

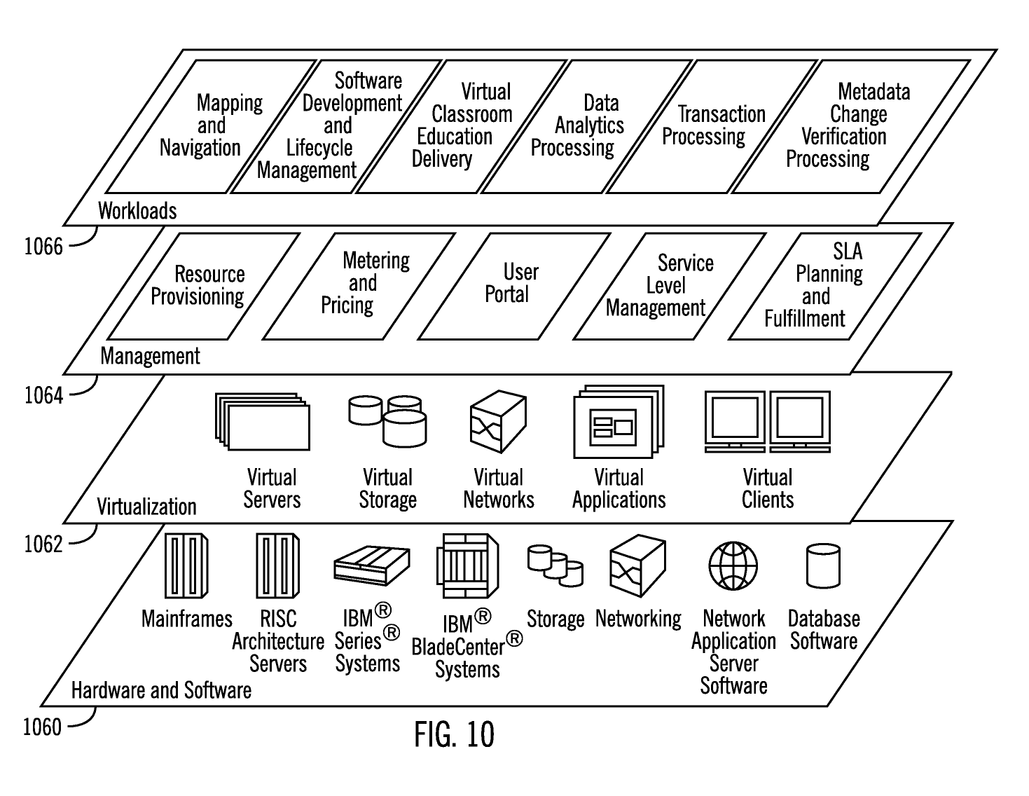

Referring now to FIG. 10, a set of functional abstraction layers provided by cloud computing environment 950 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 1060 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 1062 provides an abstraction layer from which the following examples of virtual entities may be provided: virtual servers; virtual storage; virtual networks, including virtual private networks; virtual applications and operating systems; and virtual clients.

In one example, management layer 1064 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 1066 provides examples of functionality for which the cloud computing environment may be utilized. Examples of workloads and functions which may be provided from this layer include: mapping and navigation; software development and lifecycle management; virtual classroom education delivery; data analytics processing; transaction processing; and metadata change verification processing.

Thus, in certain embodiments, software or a program, implementing metadata change verification processing in accordance with embodiments described herein, is provided as a service in a cloud environment.

In certain embodiments, the computing device 100 has the architecture of computing node 810. In certain embodiments, the computing device 100 is part of a cloud environment. In certain alternative embodiments, the computing device 100 is not part of a cloud environment.

### Additional Embodiment Details

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1-6. (canceled)

7. A computer program product, the computer program product comprising a computer readable storage medium having program code embodied therewith, the program code executable by at least one processor to perform:
in response to receiving a change to a metadata of a document, requesting a reason for the change;
in response to receiving the reason, saving the reason as additional metadata for the document; and
associating a reason indicator with the metadata.

8. The computer program product of claim 7, wherein the program code is executable by the at least one processor to perform:
adding the document to a document management system.

9. The computer program product of claim 7, wherein the program code is executable by the at least one processor to perform:
in response to receiving selection of the reason indicator, displaying the reason in a verification reason user interface.

10. The computer program product of claim 7, wherein the change to metadata is received as part of a verification phase of a capture process.

11. The computer program product of claim 7, wherein the metadata and the reason are stored in a row of a database table.

12. The computer program product of claim 7, wherein a Software as a Service (SaaS) is configured to perform the computer program product operations.

13. A computer system, comprising:
one or more processors, one or more computer-readable memories and one or more computer-readable, tangible storage devices; and
program instructions, stored on at least one of the one or more computer-readable, tangible storage devices for execution by at least one of the one or more processors via at least one of the one or more memories, to perform:
in response to receiving a change to a metadata of a document, requesting a reason for the change;
in response to receiving the reason, saving the reason as additional metadata for the document; and
associating a reason indicator with the metadata.

14. The computer system of claim 13, wherein the program instructions, stored on at least one of the one or more computer-readable, tangible storage devices for execution by at least one of the one or more processors via at least one of the one or more memories, perform:
adding the document to a document management system.

15. The computer system of claim 13, wherein the program instructions, stored on at least one of the one or more computer-readable, tangible storage devices for execution by at least one of the one or more processors via at least one of the one or more memories, perform:
in response to receiving selection of the reason indicator, displaying the reason in a verification reason user interface.

16. The computer system of claim 13, wherein the change to metadata is received as part of a verification phase of a capture process.

17. The computer system of claim 13, wherein the metadata and the reason are stored in a row of a database table.

18. The computer system of claim 13, wherein a Software as a Service (SaaS) is configured to perform the system operations.
